(19) United States
(12) Patent Application Publication
(10) Pub. No.: US 2007/0015018 A1
(43) Pub. Date: Jan. 18, 2007

(54) Information processing apparatus and operation control method

(75) Inventor: Tomonori Tsutsui, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Minato-ku (JP)

(21) Appl. No.: 11/486,166

(22) Filed: Jul. 14, 2006

(30) Foreign Application Priority Data
Jul. 14, 2005 (JP) 2005-205897

(51) Int. Cl. H01M 8/04

(52) U.S. Cl. 429/22; 429/13

(57) ABSTRACT

An information processing apparatus includes a main body to which a fuel cell unit is connectable. The fuel cell unit includes a fuel cell and a controller which controls a power generation operation of the fuel cell. The information processing apparatus also includes a control unit provided in the main body to start the power generation operation of the fuel cell when the main body is powered on.

### CROSS-REFERENCE TO RELATED APPLICATIONS

This application is based upon and claims the benefit of priority from Japanese Patent Application No. 2005-205897, filed Jul. 14, 2005, the entire contents of which are incorporated herein by reference.

### BACKGROUND

1. Field

One embodiment of the invention relates to an information processing apparatus such as a personal computer, and a method of controlling the operation of a fuel cell unit connected to the information processing apparatus.

2. Description of the Related Art

Secondary cells (batteries) such as lithium-ion batteries are generally used mainly as power supplies for portable information processing apparatuses such as a notebook personal computer and personal digital assistant (PDA). The portable information processing apparatuses have recently increased in power consumption due to their higher performance. Further, it is required that time for driving the portable information processing apparatuses be lengthened by a battery. Accordingly, a high-power, small-sized fuel cell that need not be charged has been expected as a new power supply.

In general, when a fuel cell unit starts to operate, it needs power for making up its power generation operation. The power is usually supplied from a secondary cell provided in the fuel cell unit, or an external power supply.

Jpn. Pat. Appln. KOKAI Publication No. 2004-127568 discloses a fuel cell system. In this system, an external power supply such as a commercial AC power supply is used as a power supply for making up a power generation operation.

The operation of a fuel cell unit is usually controlled by an operation control switch mounted on the fuel cell unit. When a user turns on the operation control switch, the fuel cell unit starts a power generation operation to generate power. When the user turns off the switch, the unit stops the power generation operation.

There is possibility that various malfunctions will occur in a portable information processing apparatus if a prior art method of controlling a fuel cell unit manually by the depression of an operation control switch is applied to the apparatus.

If a user powers on the portable information processing apparatus without turning on the operation control switch, the power generation operation of the fuel cell unit does not start for a long time. The battery included in the portable information processing apparatus will be therefore exhausted.

If the user powers off the portable information processing apparatus without turning off the operation control switch, the fuel cell unit will generate useless power even in the off state of the apparatus.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary external view of a fuel cell unit connectable to an information processing apparatus according to an embodiment of the invention;

FIG. 2 is an exemplary external view of the fuel cell unit shown in FIG. 1, to which the information processing apparatus according to the embodiment of the invention is connected;

FIG. 3 is an exemplary block diagram of a configuration of the fuel cell unit shown in FIG. 1;

FIG. 4 is an exemplary block diagram illustrating an interface between the information processing apparatus according to the embodiment of the invention and the fuel cell unit shown in FIG. 1;

FIG. 5 is an exemplary diagram illustrating a state transition of the fuel cell unit shown in FIG. 1; and

FIG. 6 is an exemplary flowchart illustrating a procedure for performing a power supply control process by the information processing apparatus according to the embodiment of the invention.

### DETAILED DESCRIPTION

Various embodiments according to the invention will be described hereinafter with reference to the accompanying drawings. In general, according to one embodiment of the invention, an information processing apparatus includes a main body to which a fuel cell unit is connectable, the fuel cell unit including a fuel cell and a controller which controls a power generation operation of the fuel cell, and a control unit provided in the main body to start the power generation operation of the fuel cell when the main body is powered on.

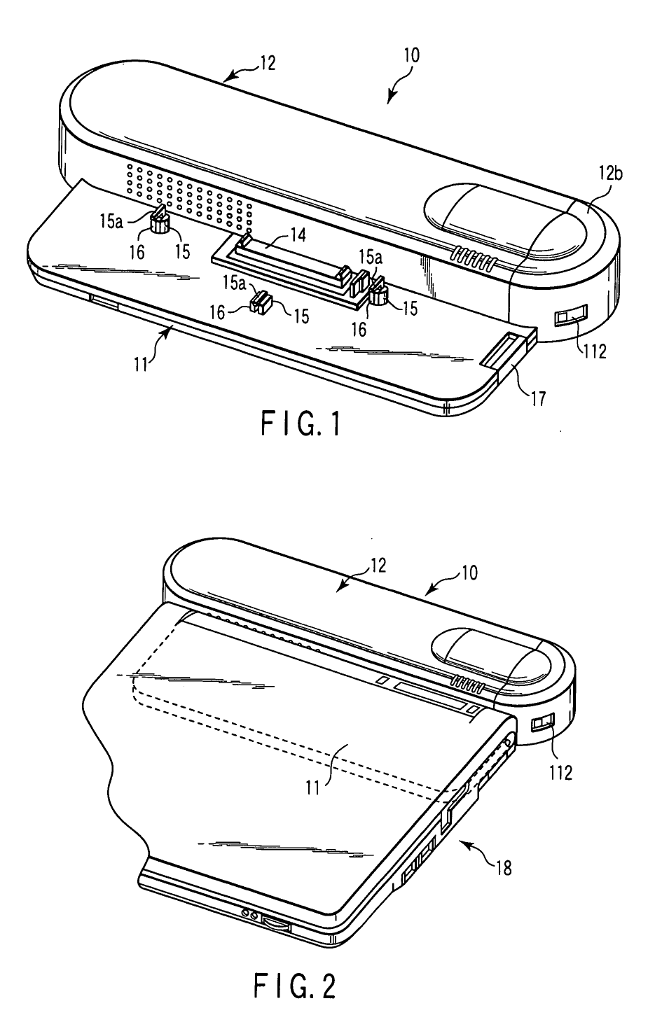

Referring to FIGS. 1 and 2, the configuration of a fuel cell unit, which is connected to an information processing apparatus according to the embodiment of the invention, will be described. FIG. 1 is a perspective view of the outward appearance of a fuel cell unit 10. FIG. 2 shows the fuel cell unit 10 that is connected to an information processing apparatus 18.

The fuel cell unit 10 is implemented as a direct methanol fuel cell (DMFC) using methanol as liquid fuel. The fuel cell unit 10 includes a fuel cell unit main body 12 and a mounting unit 11 extended from the main body 12. The mounting unit 11 is flat and rectangular. The rear portion of the information processing apparatus 18 can be mounted on the mounting unit 11. The information processing apparatus 18 is implemented as, for example, a portable notebook personal computer.

The fuel cell unit main body 12 includes a power generation unit. The power generation unit has a fuel cell (DMFC stack) that generates power by chemical reaction, a mixing tank, and a plurality of auxiliary machines (pump, valve, etc.) that compose a dilution circulating system. The mixing tank is designed to mix liquid fuel (methanol) and water collected from the DMFC stack into a low-concentration fuel aqueous solution (methanol aqueous solution) that is to be supplied to the DMFC stack. In the dilution circulating system, the methanol aqueous solution is circulated between the mixing tank and the DMFC stack, and the water collected from the DMFC stack is supplied to the mixing tank. The collected water is reused to generate a methanol aqueous solution.

A detachable fuel cartridge is provided at, for example, the inner right end of the fuel cell unit main body 12. A cover 12b is provided detachably from the main body 12 to exchange the fuel cartridge.

A docking connector 14 is provided on the top surface of the mounting unit 11 as a connection unit for connecting the mounting unit 11 to the main body of the information processing apparatus 18. Another docking connector is provided on, for example, the rear bottom of the main body of the apparatus 18 as a connection unit for connecting the main body of the apparatus 18 to the fuel cell unit 10. This docking connector is connected to the docking connector 14 mechanically and electrically.

Three combinations each having positioning projections 15 and 16 and a hook 15a are provided on the mounting unit 11. The hook 15a serves as a lock mechanism for fixing the main body 12 to the rear end portion of the information processing apparatus 18.

The three combinations are inserted into their corresponding three holes in the rear bottom of the information processing apparatus 18 when the rear portion of the apparatus 18 is mounted on the mounting unit 11 as shown in FIG. 2. The hook 15a is locked into its corresponding hole in the bottom of the apparatus 18. Thus, the fuel cell unit main body 12 is locked to the rear end portion of the main body of the apparatus 18 when the main body 12 is electrically connected to the apparatus 18.

An eject lever switch 17 is provided at, for example, the right end of the mounting unit 11 movably from side to side. When a user moves the switch 17 to the left, the hooks 15a slide to the rear and are unlocked.

An ON/OFF switch 112 is provided on, for example, the right side of the fuel cell unit main body 12 to permit or inhibit the power generation of the fuel cell unit 10. The ON/OFF switch 112 is composed of, for example, a slide switch. When the user sets the ON/OFF switch 112 in an ON position, the power generation of the fuel cell unit 10 is permitted. When the user sets the ON/OFF switch 112 in an OFF position, the power generation is inhibited.

The fuel cell unit 10 shown in FIGS. 1 and 2 can be varied in shape and size, and the docking connector 14 can be varied in shape and position.

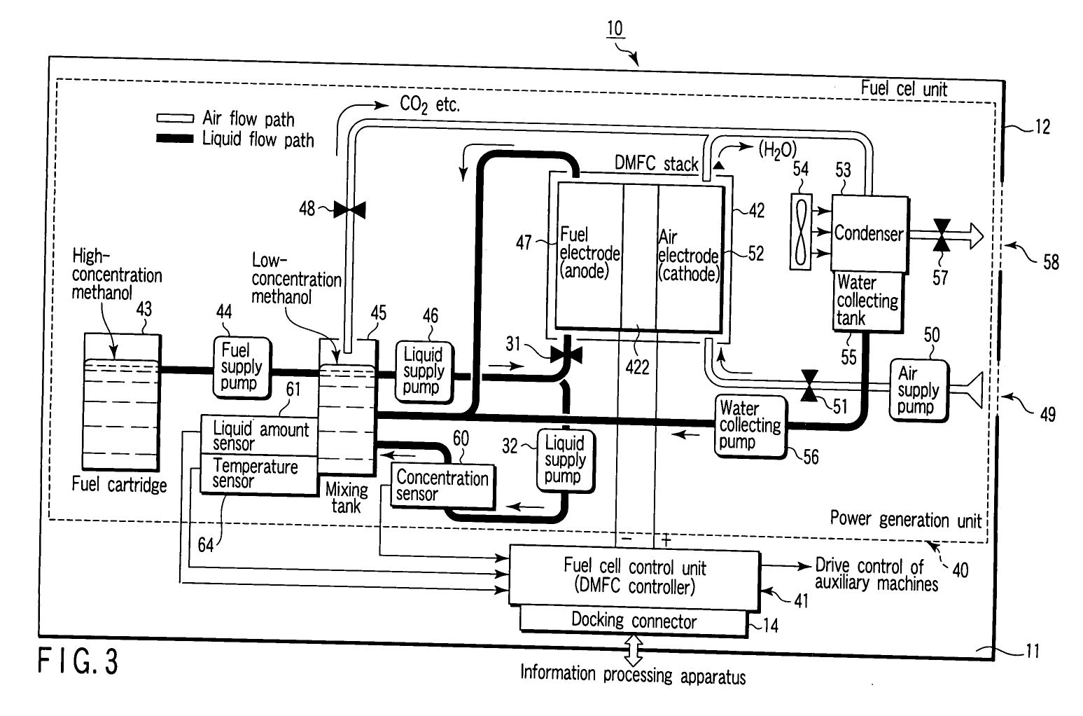

The internal configuration of the fuel cell unit 10 will be described with reference to FIG. 3.

The fuel cell unit 10 includes a power generation unit 40 and a fuel cell control unit 41. The unit 41 has a controller (DMFC controller) for controlling the power generation operation of the power generation unit 40. The unit 41 also serves as a communication control unit that communicates with the information processing apparatus 18. The power generation unit 40 is provided in the fuel cell unit main body 12, and the fuel cell control unit 41 is provided in the mounting unit 11.

The power generation unit 40 has a DMFC stack 42 and a fuel cartridge 43. The DMFC stack 42 is a fuel cell serving as an electromotive unit that generates power by chemical reaction. The power generation operation causes the DMFC stack 42 to generate heat. In order to prevent the heat from being transmitted to the components around the DMFC stack 42, the outer or inner surface of the housing of the DMFC stack 42 is coated with heat insulation materials. A high-concentration methanol solution is sealed in the fuel cartridge 43.

In the DMFC, generally, a crossover phenomenon has to be lessened to increase power generation efficiency. It is thus effective to dilute the high-concentration methanol to lower its concentration and then inject it into an anode (fuel electrode) 47 of the DMFC stack 42. To achieve this, the fuel cell unit 10 adopts a dilution circulating system. The dilution circulating system includes a flow path that is roughly divided into a liquid flow path and an air flow path.

First, a relationship in connection between components provided in the liquid flow path will be described.

In the liquid flow path, the output of the fuel cartridge 43 is connected to a fuel supply pump 44 through a pipe, and the output of the fuel supply pump 44 is connected to a mixing tank 45 through a pipe. The output of the mixing tank 45 is connected to a liquid supply pump 46 through a pipe, and the output of the liquid supply pump 46 is connected to the fuel electrode 47 of the DMFC stack 42 through a pipe and a liquid supply valve 31. The output of the fuel electrode 47 is connected to the mixing tank 45 through a pipe. The liquid supply pump 46 circulates a methanol aqueous solution that is a liquid fuel between the mixing tank 45 and DMFC stack 42. The liquid flow path through which the methanol aqueous solution circulates (flows back) by the power of the pump 46 is called a first liquid flow path. The liquid supply pump 46 can be provided on the output side of the fuel electrode 47 instead of the input side thereof. The liquid supply valve 31 need not necessarily be required.

The output of a water collecting tank 55 is connected to a water collecting pump 56 through a pipe, and the output of the water collecting pump 56 is connected to the mixing tank 45 through a pipe.

A branch is provided between the liquid supply pump 46 and fuel electrode 47 in the first liquid flow path, and another flow path (e.g., a pipe) through which a methanol aqueous solution flows back to the mixing tank 45 via the branch is provided. This flow path is called a second liquid flow path. The second liquid flow path is provided exclusively for detecting the concentration of methanol in the methanol aqueous solution. The second flow path includes a liquid supply pump 32, and the output of the liquid supply pump 32 is connected to the mixing tank 45 through a concentration sensor 60. The liquid supply pump 32 is not necessarily required.

In the air flow path, an air supply pump 50 is connected to an air electrode (cathode) 52 of the DMFC stack 42 through an air supply valve 51. The output of the air electrode 52 is connected to a condenser 53 through a mixing tank valve 48. The condenser 53 is connected to an exhaust hole 58 through an exhaust valve 57. The condenser 53 has a fin for condensing water vapor effectively. A cooling fan 54 is provided close to the condenser 53.

The mechanism for generating power from the power generation unit 40 of the fuel cell unit 10 will be described in line with the flow of fuel and air (oxygen).

First, high-concentration methanol in the fuel cartridge 43 flows into the mixing tank 45 through the fuel supply pump 44. In the mixing tank 45, the high-concentration methanol is mixed and diluted with the collected water, low-concentration methanol (unreacted methanol) from the fuel electrode 47, and the like to generate low-concentration methanol. The concentration of the low-concentration methanol is controlled to remain at such a concentration (e.g., 3% to 6%) as to increase power generation efficiency. This concentration control can be achieved by the fuel cell control unit 41 to control the amount of high-concentration methanol supplied to the mixing tank 45 through the fuel supply pump 44 or the amount of water flowing back to the mixing tank 45 by the water collecting pump 56, on the basis of a detection result of the concentration sensor 60.

The mixing tank 45 includes a liquid amount sensor 61 for sensing an amount of methanol aqueous solution in the tank 45 and a temperature sensor 64 for sensing temperatures. The sensing results of these sensors are sent to the fuel cell control unit 41 and used for controlling the power generation unit 40.

The methanol aqueous solution diluted in the mixing tank 45 is pressurized by the liquid supply pump 46 and injected into the fuel electrode (anode) 47 of the DMFC stack 42. The fuel electrode 47 generates electrons by oxidation reaction of methanol. The oxidation reaction generates hydrogen ions (H+), and the hydrogen ions reach the air electrode (cathode) 52 through a solid polyelectrolyte film 422 in the DMFC stack 42.

The oxidation reaction also generates carbon dioxide. On one hand, the carbon dioxide flows back to the mixing tank 45 together with an unreacted methanol solution. The carbon dioxide is vaporized in the mixing tank 45, supplied to the condenser 53 through the mixing tank valve 48, and finally exhausted from the exhaust hole 58 through the exhaust valve 57.

On the other hand, air (oxygen) is taken in through an air intake 49, pressurized by the air supply pump 50 and injected into the air electrode (cathode) 52 through the air supply valve 51. In the air electrode 52, the reductive reaction of oxygen (O₂) progresses, and water (H₂O) is generated as water vapor from electrons (e-) from an external load, hydrogen ions (H+) from the fuel electrode 47, and oxygen (O₂). This water vapor is discharged from the air electrode 52 and supplied to the condenser 53. In the condenser 53, the water vapor is cooled into water (liquid) by the cooling fan 54 and stored temporarily in the water collecting tank 55. The collected water flows back to the mixing tank 45 through the water collecting pump 56.

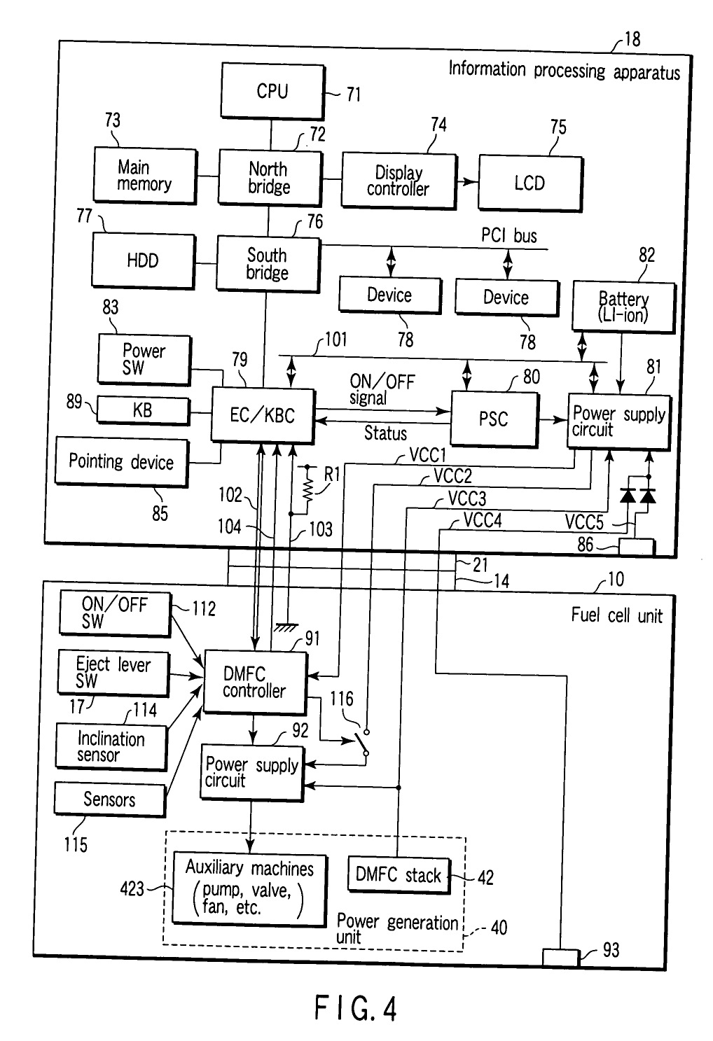

The configuration of each of the information processing apparatus 18 and fuel cell unit 10 will be described with reference to FIG. 4.

The information processing apparatus 18 includes a CPU 71, a north bridge 72, a main memory 73, a display controller 74, a liquid crystal display (LCD) 75, a south bridge 76, a hard disk drive (HDD) 77, a plurality of peripheral component interconnect (PCI) devices 78, an embedded controller/keyboard controller IC (EC/KBC) 79, a power supply controller (PSC) 80, a power supply circuit 81, lithium-ion battery (secondary cell) 82, a power switch 83, a keyboard (KB) 84 and a pointing device 85.

The CPU 71 is a processor provided to control the operation of the information processing apparatus 18 and executes an operating system and various application programs which are loaded into the main memory 73 from the HDD 77. The north bridge 72 is a bridge device for connecting the local bus of the CPU 71 and the south bridge 76. The north bridge 72 also includes a memory controller for controlling access to the main memory 73. The north bridge 72 has a function of communicating with the display controller 74 via an accelerated graphics port (AGP) bus.

The display controller 74 controls the LCD 75 that is used as a display monitor of the information processing apparatus 18. The EC/KBC 79 is a one-chip microcomputer in which an embedded controller for power management and a keyboard controller for controlling the keyboard (KB) 84 and pointing device 85 are integrated.

The EC/KBC 79 has a function of powering on/powering off the information processing apparatus 18 by a user's depression of the power switch 83. The power-on/power-off of the apparatus 18 is controlled by the EC/KBC 79 and PSC 80 that are associated with each other. Upon receiving an ON signal from the EC/KBC 79, the PSC 80 controls the power supply circuit 81 to power on the apparatus 18. Upon receiving an OFF signal therefrom, the PSC 80 controls the power supply circuit 81 to power off the apparatus 18. The power supply circuit 81 generates operation power to be supplied to each of the components by selectively using power supplied from the battery (secondary cell) 82, power supplied from an external power supply (AC adapter connected to an external power supply connection terminal 86 when necessary), and power supplied from the fuel cell unit 10.

The EC/KBC 79 serves as a control unit to control the power generation operation of the fuel cell unit 10 automatically.

The EC/KBC 79, PSC 80, power supply circuit 81 and secondary battery 82 are connected to each other via a serial bus 101 such as an Inter-IC (I²C) bus.

The fuel cell unit 10 includes a DMFC controller 91 and a power supply circuit 92 in addition to the power generation unit 40. The DMFC controller 91 is a controller for controlling the power generation operation of the DMFC stack 42, i.e., the power generation operation of the power generation unit 40. The DMFC controller 91 is composed of a one-chip microcomputer. The DMFC controller 91 permits or inhibits the power generation operation of the power generation unit 40 in accordance with the setting position of the ON/OFF switch 112. The DMFC controller 91 also has a function of detecting a position of the eject lever switch 17 to confirm whether the fuel cell unit 10 is locked or not. Further, the DMFC controller 91 has a function of checking a state of the fuel cell unit 10 to confirm whether the unit 10 is normal or abnormal. This function is carried out using an inclination sensor (acceleration sensor) 114 and a sensor 115 provided in the fuel cell unit 10. The sensor 15 includes the above-described concentration sensor 60, liquid amount sensor 61 and temperature sensor 64.

The power generation unit 40 includes the DMFC stack 42 and a plurality of auxiliary machines 423 that compose the dilution circulating system. The DMFC controller 91 controls the driving of the auxiliary machines 423. The power supply circuit 92 generates operation power to be supplied to each of the auxiliary machines 423. The power supply circuit 92 generates the operation power from power supplied from the battery (secondary cell) 82 until the power generation unit 40 generates power having a given value. When the power having a given value is generated, the power supply circuit 92 generates the operation power from the power generated by the unit 40.

As described above, the power for driving the auxiliary machines 423 is supplied to the fuel cell unit 10 from the information processing apparatus 18. It is therefore unnecessary to provide any secondary cell in the fuel cell unit 10.

An interface between the fuel cell unit 10 and the information processing apparatus 18 will be described.

To achieve the interface, a serial bus 102 such as an I²C bus, a docking detection signal line 103, a locked-state detection signal line 104 and four power supply lines (VCC1, VCC2, VCC3 and VCC4) 104 are used.

The serial bus 102 is an interface for communication between the EC/KBC 79 of the information processing apparatus 18 and the DMFC controller 91 of the fuel cell unit 10. The EC/KBC 79 transmits various commands to the DMFC controller 91 through the serial bus 102 to control the operation of the fuel cell unit 10. There are a power generation start command (first signal) and a power generation stop command (second signal) as commands supplied to the DMFC controller 91 from the EC/KBC 79. The power generation start command is a command for instructing the DMFC controller 91 to start to generate power. The power generation stop command is a command for instructing the DMFC controller 91 to stop generating power.

The docking detection signal line 103 is a signal line for detecting whether the fuel cell unit 10 is connected to the information processing apparatus 18. In the information processing apparatus 18, the docking detection signal line 103 is connected to a power supply terminal via a pull-up resistor R1. In the fuel cell unit 10, the docking detection signal line 103 is grounded. When a docking connector 21 of the apparatus 18 is connected to the docking connector 14 of the fuel cell unit 10, the potential of the docking detection signal line 103 changes from a logic level “H” to a logic level “L.” The EC/KBC 79 detects whether the fuel cell unit 10 is connected to the information processing apparatus 18 in accordance with the potential of the docking detection signal line 103.

The locked-state detection signal line 104 is a signal line provided to confirm the state of the lock mechanism. The EC/KBC 79 detects whether the fuel cell unit main body 12 is locked to the information processing apparatus 18 in accordance with the voltage value of the locked-state detection signal line 104.

The two power supply lines VCC1 and VCC2 are used to supply operation power to the fuel cell unit 10 from the information processing apparatus 18. The power supply line VCC1 is a power supply line for supplying operation power to the DMFC controller 91. The power supply circuit 81 of the apparatus 18 generates operation power using the power of the battery (secondary cell) 82 and supplies it to the DMFC controller 91 via the power supply line VCC1. The power supply line VCC2 supplies power to the fuel cell unit 10 to drive the auxiliary machines 423 and is connected to the power supply circuit 92 of the unit 10 through a switch 116. The power supply circuit 81 of the apparatus 18 generates operation power for driving the auxiliary machines 423 using the power of the battery (secondary cell) 82 and supplies it to the power supply circuit 92 of the unit 10 through the power supply line VCC2. When the power generation unit 40 generates power having a given value, the DMFC controller 91 turns off the switch 116.

The power supply line VCC3 supplies power to the information processing apparatus 18 from the DMFC stack 42. The power supply line VCC4 supplies power to the apparatus 18 from an external power supply (AC adapter) connected to an external power supply connection terminal 93 of the fuel cell unit 10. When the unit 10 is docked in the apparatus 18, the external power supply connection terminal 86 provided in the apparatus 18 is covered with the unit 10. In this docking state, the external power supply (AC adapter) is connected to the external power supply connection terminal 93.

In the information processing apparatus 18, the power supply line VCC4 is wired-OR-connected to the power supply line VCC5 that is connected to the external power supply connection terminal 86, and its connection node is connected to the power supply circuit 81.

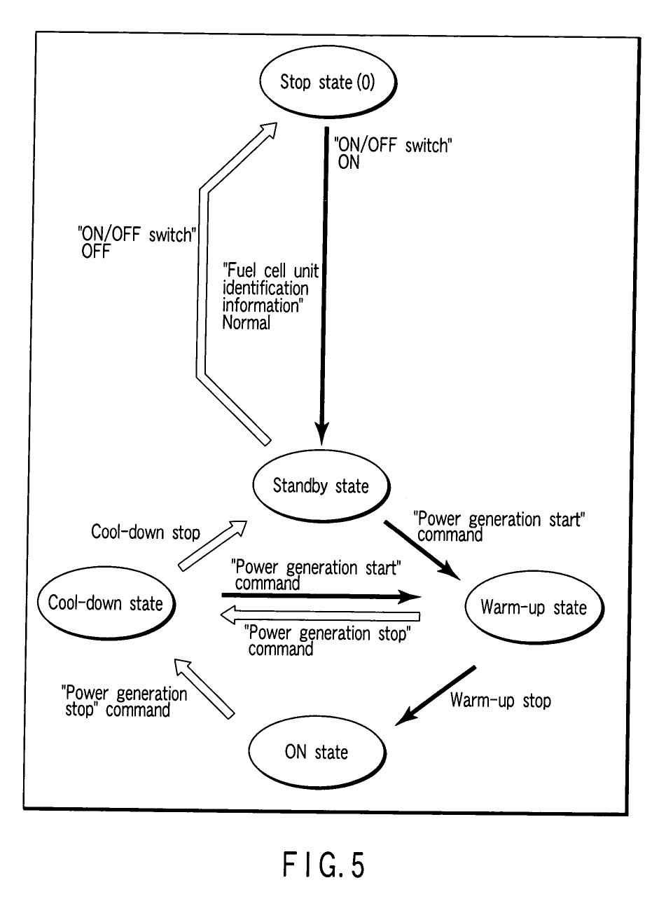

The state transition of the fuel cell unit 10 will be described with reference to FIG. 5.

While the ON/OFF switch 112 is set in OFF state, the state of the fuel cell unit 10 is maintained in “stop state (0).” When a user sets the ON/OFF switch 112 in the ON position, communication can be carried out between the EC/KBC 79 and the DMFC controller 91. The EC/KBC 79 performs communication with the DMFC controller 91 via the serial bus 102 and reads fuel cell identification information out of the DMFC controller 91, a dedicated EEPROM or the like. If the EC/KBC 79 confirms that the fuel cell unit 10 connected to the information processing apparatus 18 is valid on the basis of the read fuel cell identification information, it sets the unit 10 in “standby state.”

When a power generation start command is received from the EC/KBC 79, the state of the fuel cell unit 10 shifts to “warm-up state.” In the “warm-up state,” the pumps 44, 46, 50 and 56, valves 48, 51 and 57 and cooling fan 54 shown in FIG. 3 are driven and thus the power generation unit 40 starts to perform a power generation operation. The methanol aqueous solution and air are injected into the DMFC stack 42 of the power generation unit 40. The power generated by the DMFC stack 42 starts to be supplied to the information processing apparatus 18. Since, however, the generated power does not reach its rated value at once, the state of the fuel cell unit 10 which continues until the power reaches the rated value, is called “warm-up state.”

When the power generated by the DMFC stack 42 reaches the rated value, the state of the fuel cell unit 10 shifts to “on state.” Thus, the DMFC controller 91 turns off the switch 116 and switches a power supply source for each of the auxiliary machines 423 from the information processing apparatus 18 to the DMFC stack 42.

If a power generation stop command is received from the EC/KBC 79 in the “warm-up state” or “on state,” the state of the fuel cell unit 10 shifts to “standby state” through a “cool-down state.” The “cool-down state” lowers the temperature of the fuel cell unit 10. In the “cool-down state,” the power generation of the power generation unit 40 is stopped, but the cooling fan 54 and the auxiliary machines necessary for cooling the respective units are driven for a given period of time.

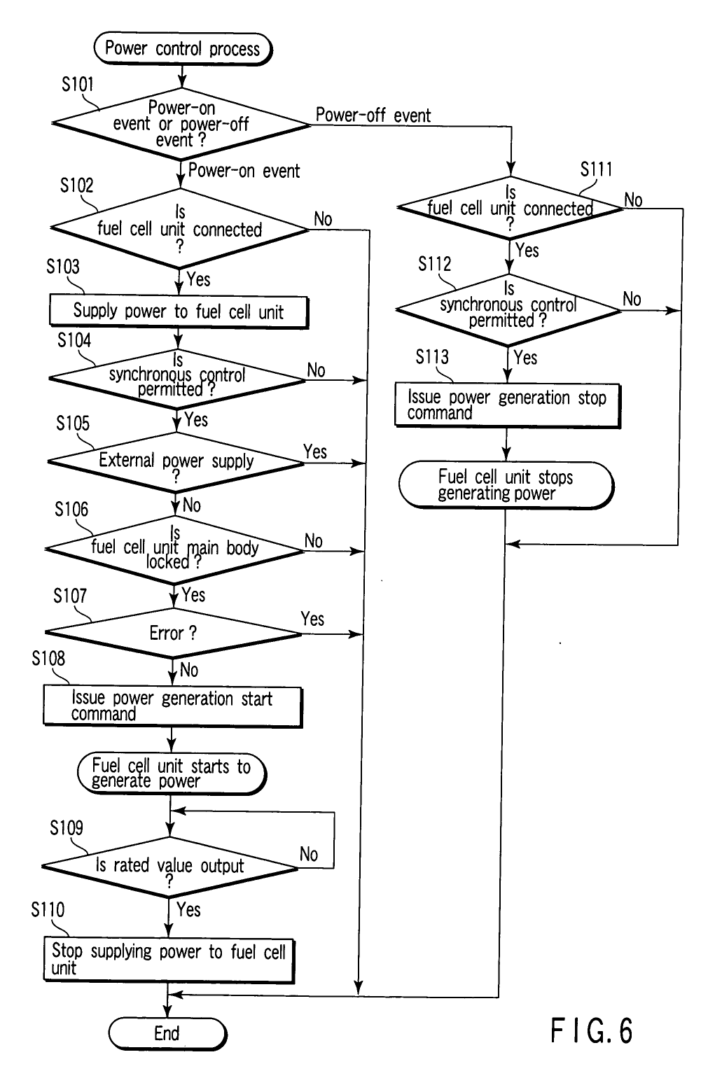

A procedure for a power control process to achieve synchronous control of controlling the operation of the fuel cell unit 10 in association with that of the information processing apparatus 18, will be described with reference to FIG. 6.

The EC/KBC 79 monitors whether a power-on event occurs while the information processing apparatus 18 is powered off (including a suspended state and a hibernated state), and monitors whether a power-off event occurs while the apparatus 18 is powered on (block S101).

The main body of the information processing apparatus 18 is powered on when a power-on event occurs in which a user depresses the power switch 83 of the apparatus 18. When the apparatus 18 is powered on, the EC/KBC 79 determines whether the fuel cell unit 10 is connected to the main body of the apparatus 18 on the basis of the potential of the docking detection signal line 103 (block S102).

If the fuel cell unit 10 is connected to the main body of the information processing apparatus 18 (YES in block S102), the EC/KBC 79 controls the power supply circuit 81 and supplies power to the fuel cell unit 10 (block S103). In block S103, the power supply circuit 81 supplies the DMFC controller 91 with power (VCC1) for driving the DMFC controller 91. Further, the power supply circuit 81 temporarily supplies the power supply circuit 92 with power (VCC2) for driving each of the auxiliary machines.

The EC/KBC 79 determines whether the synchronous control is permitted (block S104). The user can decide in advance whether to execute the synchronous control.

If the synchronous control is permitted (YES in block S104), the EC/KBC 79 cooperates with the power supply circuit 81 to determine whether the information processing apparatus 18 is supplied with power from an external power supply, or whether the apparatus 18 is supplied with power from an AC adapter connected to the apparatus 18 or the unit 10 (block S105).

If the information processing apparatus 18 is supplied with power from the external power supply (YES in block S105), the fuel cell unit 10 need not be operated; therefore, the EC/KBC 79 stops the power control process to inhibit the unit 10 from starting to generate power.

If the apparatus 18 is not supplied with power from the external power supply (NO in block S105), the EC/KBC 79 determines whether the fuel cell unit main body 12 is locked in the apparatus 18 (block S106). In block S106, the EC/KBC 79 checks the voltage value of the locked-state detection signal line 104 from the DMFC controller 91 to confirm the state of the lock mechanism.

If the fuel cell unit main body 12 is not locked in the information processing apparatus 18 is released (NO in block S106), the EC/KBC 79 stops the power control process to inhibit the fuel cell unit 10 from starting to generate power for safety reasons.

If the EC/KBC 79 confirms that the main body 12 is locked in the apparatus 18 (YES in block S106), it inquires the state of the fuel cell unit 10 of the DMFC controller 91 via the serial bus 102 to determine whether the unit 10 is abnormal (inclination abnormality, internal temperature abnormality, out of fuel, water leak, etc.) (block S107).

If the fuel cell unit 10 is abnormal (YES in block S107), the EC/KBC 79 stops the power control process to inhibit the unit 10 from starting to generate power for safety reasons.

If the fuel cell unit 10 is not abnormal (NO in block S107), the EC/KBC 79 transmits a power generation start command to the DMFC controller 91 via the serial bus 102 to start the power generation operation of the power generation unit 40 (block S108). The supply of power (VCC2) to the unit 10 can be started in block S108.

After that, the EC/KBC 79 cooperates with the power supply circuit 81 to determine whether the power generated from the power generation unit 40 reaches a given value (rated value) (block S109). If the generated power reaches the given value (rated value), the EC/KBC 79 controls the power supply circuit 81 to stop the supply of power (VCC2) to the fuel cell unit 10 (block S110). The power supply circuit 81 switches the power supply for driving the information processing apparatus 18 from the battery (secondary cell) 82 to the power (VCC4) supplied from the fuel cell unit 10. In the fuel cell unit 10, the DMFC controller 91 turns off the switch 116 to switch the power for driving each of the auxiliary machines from the power (VCC2) to the power generated from the power generation unit 40.

As described above, according to the embodiment of the invention, the power generation operation of the fuel cell unit 10 automatically starts in association with the power-on of the information processing apparatus 18.

Even though the fuel cell unit 10 is connected to the information processing apparatus 18 while the apparatus 18 is powered on, the EC/KBC 79 performs the process after block S102. Thus, even though the unit 10 is connected to the apparatus 18 that is powered on, the unit 10 automatically starts the power generation operation.

If a power-off event occurs, the EC/KBC 79 performs the following process in the power supply sequence for powering off the information processing apparatus 18.

On the basis of the potential of the docking detection signal line 103, the EC/KBC 79 determines whether the fuel cell unit 10 is connected to the main body of the information processing apparatus 18 (block S111). If the unit 10 is connected to the main body of the apparatus 18 (YES in block S111), the EC/KBC 79 determines whether the synchronous control is permitted (block S112). If the synchronous control is permitted (YES in block S111), the EC/KBC 79 transmits the power generation stop command to the DMFC controller 91 via the serial bus 102 to stop the power generation operation of the power generation unit 40 (block S113).

As described above, according to the embodiment of the invention, the power generation operation of the fuel cell unit 10 is automatically stopped in association with the power-off of the information processing apparatus 18.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a main body to which a fuel cell unit is connectable, the fuel cell unit including a fuel cell and a controller which controls a power generation operation of the fuel cell; and
a control unit provided in the main body to start the power generation operation of the fuel cell when the main body is powered on.

2. The information processing apparatus according to claim 1, wherein the control unit is configured to stop the power generation operation of the fuel cell when the main body is powered off.

3. The information processing apparatus according to claim 1, wherein the fuel cell unit includes a mixing tank which mixes liquid fuel and water into a fuel aqueous solution to be supplied to the fuel cell and a pump which sends out water generated by the fuel cell to the mixing tank, and the controller is configured to control driving of the pump.

4. The information processing apparatus according to claim 1, wherein the control unit is configured to determine whether the fuel cell unit is connected to the main body when the main body is powered on and start the power generation operation of the fuel cell when the control unit determines that the fuel cell unit is connected to the main body.

5. The information processing apparatus according to claim 1, wherein the control unit is configured to determine whether the fuel cell unit is abnormal when the main body is powered on and start a power generation operation of the fuel cell when the control unit determines that the fuel cell unit is not abnormal.

6. The information processing apparatus according to claim 1, further comprising a power supply circuit provided in the main body to supply power to the fuel cell unit until power generated by the fuel cell unit reaches a given value when the main body is powered on.

7. The information processing apparatus according to claim 1, wherein the control unit is configured to determine whether an external power supply supplies power to the main body when the main body is powered on and start the power generation operation of the fuel cell when the control unit determines that the external power supply does not supply power to the main body.

8. An information processing apparatus comprising:
a main body to be driven by at least one of a secondary cell and a fuel cell unit,
means for, when the main body is powered on, supplying the fuel cell unit with power to drive the fuel cell unit using the secondary cell and starting a power generation operation of the fuel cell unit.

9. The information processing apparatus according to claim 8, further comprising means for stopping the power generation operation of the fuel cell unit when the main body is powered off.

10. The information processing apparatus according to claim 8, wherein the fuel cell unit includes a fuel cell, a mixing tank which mixes liquid fuel and water into a fuel aqueous solution to be supplied to the fuel cell, a pump which sends out water generated by the fuel cell to the mixing tank, and a controller configured to control driving of the pump.

11. A method of controlling an operation of a fuel cell unit which is connectable to an information processing apparatus and includes a fuel cell and a controller that controls a power generation operation of the fuel cell, the method comprising:
determining whether the fuel cell unit is connected to the information processing apparatus when the information processing apparatus is powered on; and
starting the power generation operation of the fuel cell when it is determined that the fuel cell unit is connected to the information processing apparatus.

12. The method according to claim 11, further comprising stopping the power generation operation of the fuel cell when the information processing apparatus is powered off.

13. The method according to claim 11, further comprising:
determining whether the fuel cell unit is abnormal when the information processing apparatus is powered on; and
inhibiting the fuel cell from starting the power generation operation when it is determined that the fuel cell unit is abnormal.

14. The method according to claim 11, further comprising supplying power to drive the fuel cell from the information processing apparatus to the fuel cell unit when the information processing apparatus is powered on.

15. The method according to claim 11, further comprising:
determining whether an external power supply supplies power to the information processing apparatus when the information processing apparatus is powered on; and
inhibiting the fuel cell from starting the power generation operation when it is determined that the external power supply supplies power to the information processing apparatus.
